(19) United States
(12) Patent Application Publication
(10) Pub. No.: US 2013/0210484 A1
(43) Pub. Date: Aug. 15, 2013

(54) METHOD AND APPARATUS FOR SUPPORTING TUNE-AWAY IN DUAL-SIM DUAL-STANDBY MOBILE DEVICES

(71) Applicant: QUALCOMM Incorporated, (US)

(72) Inventors: Rajagopal JEENAGALA, San Diego, CA (US); Ling HANG, San Diego, CA (US); Chi-Ping HSU, San Diego, CA (US)

(73) Assignee: QUALCOMM INCORPORATED, San Diego, CA (US)

(21) Appl. No.: 13/766,372

(22) Filed: Feb. 13, 2013

Related U.S. Application Data
(60) Provisional application No. 61/598,431, filed on Feb. 14, 2012.

(51) Int. Cl. H04W 88/06

(52) U.S. Cl. CPC H04W 88/06
USPC 455/552.1

(57) ABSTRACT

Aspects of the disclosure provide methods and apparatuses for improving tune-away in some dual-SIM, dual standby mobile devices. For example, methods are provided for setting a first subscription of a first subscriber identity module (SIM) of a user equipment (UE) as a designated data subscription (DDS), wherein the first subscription supports only first technology type communication services, and setting a second subscription of a second SIM of the UE to support only the first technology type communication services in response to setting the first subscription as the DDS, wherein the second subscription is able to support both the first technology type communication services and second technology type communication services different than the first technology type communication services. As such, improved tune-away may be accomplished.

### CLAIM OF PRIORITY UNDER 45 U.S.C. §119

The present Application for Patent claims priority to Provisional Application No. 61/598,431 filed Feb. 14, 2012, entitled “Method and Apparatus for Supporting Tune-Away in DSDS Mobile Devices,” which is assigned to the assignee hereof, and hereby expressly incorporated by reference herein.

### BACKGROUND

1. Field

Aspects of the present disclosure relate generally to wireless communication systems, and more particularly, to tune-away in DSDS devices.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

Additionally, some wireless devices are configured to facilitate communication on two separate networks via two separate subscriptions. For instance, dual-Subscription Identity Module (SIM), dual standby (DSDS) devices may include two SIM cards—one card for a first subscription and a second card for a second subscription. In DSDS devices, a user may set one or the two subscriptions as a designated data subscription (DDS), where the chosen subscription will serve as the provider of data services to the wireless device. Furthermore, DSDS devices may support tune-away functionality, whereby when the user is communicating with a network via a first subscription, the mobile device will continue to monitor the second subscription and will tune away from the first subscription if the mobile device receives a page, such as a voice call, via the second subscription. For example, where a user has chosen the first subscription as its DDS and is utilizing the first subscription to browse the internet, the user may still receive a voice call via the second subscription.

Additionally, each subscription may be associated with one or more technology types. In some non-limiting examples, a first subscription may exclusively support 2 G communication technology, such GSM, while the second subscription may support one or more 3 G communication technologies (e.g. WCDMA) and 2 G communication technology. Some DSDS mobile device platforms, however, do not support 2G to 3G tune-away. Therefore, where a user has chosen its DDS as a first subscription that supports only 2 G communication technology and a 3G network associated with the second subscription attempts to page the device on the second subscription, the mobile device may not receive the page.

Therefore, a method and apparatus for supporting 2G subscription to 3G-enabled subscription tune-away in mobile devices is needed where, for example, the device does not support direct 2G to 3G tune-away.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example aspect, the present disclosure presents a method of supporting tune-away in a wireless system, which includes setting a first subscription of a first SIM of a user equipment (UE) as a DDS. In addition, in some examples, this first subscription may support only first technology type communication services. Furthermore, example methods may include setting a second subscription of a second SIM to support only the first technology type communication services in response to setting the first subscription as the DDS. In an additional aspect, the second subscription may be able to support both the first technology type communication services and second technology type communication services different than the first technology type communication services.

Further, the present disclosure presents an apparatus for supporting tune-away in a wireless system, which includes means for setting a first subscription of a first subscriber identity module as a designated data subscription. In some examples, the first subscription may support only first technology type communication services. Additionally, some example apparatuses may include means for setting a second subscription of a second SIM to support only the first technology type communication services in response to setting the first subscription as the DDS. In a further example aspect, the second subscription may be able to support both the first technology type communication services and second technology type communication services different than the first technology type communication services.

Additionally the present disclosure presents a computer program product, which may include a computer-readable medium that includes code for setting a first subscription of a first subscriber identity module of a user equipment as a designated data subscription, wherein the first subscription supports only first technology type communication services. Furthermore, the computer program product may include code for setting a second subscription of a second SIM to support only the first technology type communication services in response to setting the first subscription as the DDS. In additional example aspects, the second subscription is able to support both the first technology type communication services and second technology type communication services different than the first technology type communication services.

In an additional examples described in the present disclosure, an apparatus for supporting tune-away is described, which may include at least one processor and a memory coupled to the at least one processor. The at least one processor may be configured to set a first subscription of a first subscriber identity module of a user equipment as a designated data subscription. Furthermore, in some examples, the first subscription may support only first technology type communication services. In addition, such example apparatuses may set a second subscription of a second SIM to support only the first technology type communication services in response to setting the first subscription as the DDS. Moreover, the second subscription may be able to support both the first technology type communication services and second technology type communication services different than the first technology type communication services.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system of aspects of the present disclosure;

FIG. 2 is a block diagram illustrating an example of an example computer device in aspects of the present disclosure;

FIG. 3 is a flow diagram illustrating aspects of a method for supporting tune-away in a UE as provided by the present disclosure;

FIG. 4 is a component diagram illustrating aspects of a logical grouping of electrical components as contemplated by the present disclosure;

FIG. 5 is a block diagram illustrating an example of a hardware implementation for an apparatus employing a processing system;

FIG. 6 is a block diagram conceptually illustrating an example of a telecommunications system;

FIG. 7 is a conceptual diagram illustrating an example of an access network.

FIG. 8 is a conceptual diagram illustrating an example of a radio protocol architecture for the user and control plane; and

FIG. 9 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure provides methods and apparatuses for supporting unique tune-away in a user equipment (UE). In most areas covered by 3G network services from a wireless network service provider, the service provider also provides overlapping 2G services. This may be especially true in emerging markets such as, but not limited to, China and India, where 2G network service coverage is typically more reliable than 3G network service. As such, users in some markets may wish to receive voice calls from the more-reliable 2G networks on a non-DDS subscription, such as a second subscription, even when the second subscription is also configured to support 3G and/or 4G services.

In such areas, where a DSDS device user has set a designated data service (DDS) to a first subscription that only provides 2G services, some devices may not support tune-away to a second subscription that provides 3G services and/or 4G services. This may result in a missed 3G page on the second subscription while the mobile device is engaged in an active data call via the first subscription. These devices may, however, support 2G to 2G tune-away. Where this is the case, because the second subscription likely supports 2G services as well as 3G services and/or 4G services, switching the second subscription to a 2G mode will allow these devices to tune-away to the second subscription during an active data call on the first subscription. As such, a page, such as a voice call, via the second subscription in 2G mode will not be missed as the device will facilitate tune-away to the second subscription in 2G mode.

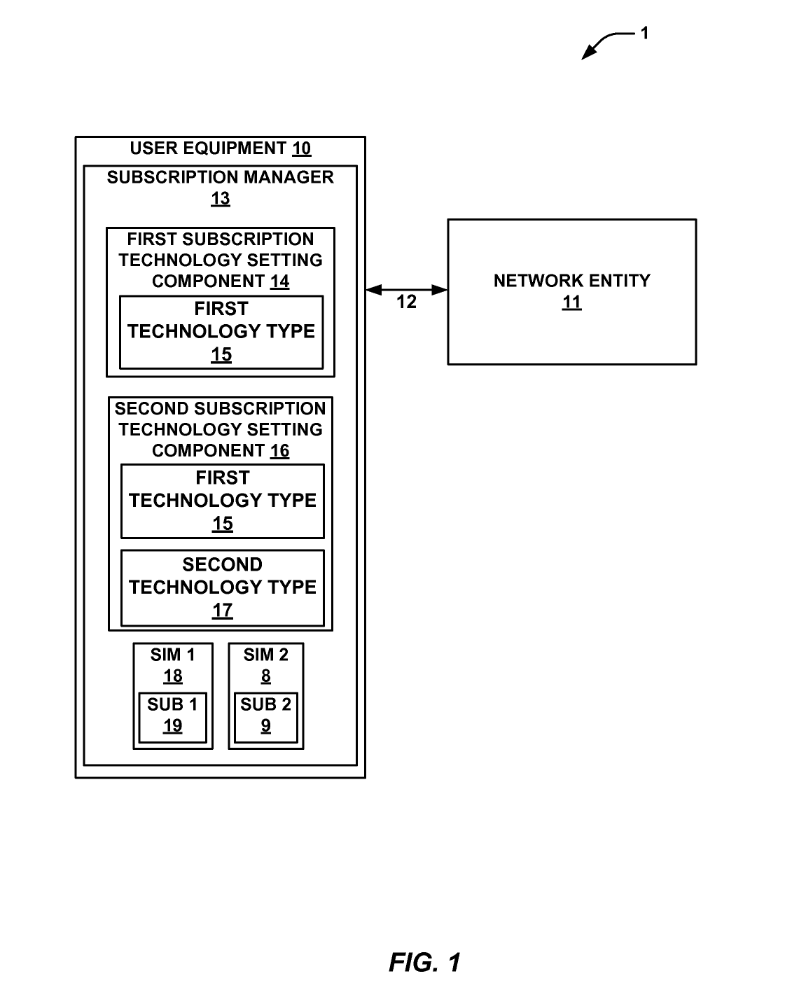

Referring to FIG. 1, a wireless communication system 1 is illustrated that enables power savings in one or more UEs. System 1 includes a UE 10 that communicates with one or more network entities 11 to receive wireless network access. Network entity 11 may include one or more of any type of network component, such as an access point, including a base station (BS) or node B, a relay, a peer-to-peer device, a radio network controller (RNC), an authentication, authorization and accounting (AAA) server, a mobile switching center (MSC), etc., that can enable UE 10 to communicate and/or that can establish and maintain a communication link 12. In addition, UE 10 may be a multi-SIM, multi-standby device, such as a dual-SIM, dual standby (DSDS) device.

Furthermore, UE 10 may include a subscription manager 13, which may be configured to manage one or more subscription technology types in UE 10. Additionally, in an aspect, subscription manager 13 may include a first subscription technology setting component 14, which may be configured to set a first subscription technology. In an aspect, first subscription technology setting component may set the first subscription technology type to a first technology type 15, which may provide first technology type communication services. Moreover, first subscription technology setting component may be configured to set a first subscription 19 as a designated data service (DDS). In some examples, the first technology type may be a 2G technology type, such as, but not limited to, GSM, GPRS, or EDGE.

In addition, UE 10 may include a second subscription technology setting component 16, which may be configured to set a second subscription technology. In an aspect, second subscription technology setting component 16 may set the second subscription technology type as the first technology type 15 or a second technology type 17, which may provide second technology type communication services. Furthermore, in an aspect, second subscription technology setting component 16 may switch a second subscription technology type from the second technology type 17 to the first technology type 15 as a result of first subscription technology setting component 14 setting the first subscription 19 as the DDS for the UE. In a further aspect, second technology type 17 may be a 3G technology, such as, but not limited to, data optimized (DO), WCDMA, Time Division Synchronous Code Division Multiple Access (TDS-CDMA), or any other third-generation mobile communications technology. Furthermore, second technology type 17 may be a 4G technology, such as, but not limited to, Long-Term Evolution (LTE), Time-Division Long-Term Evolution (TD-LTE), or any other fourth-generation mobile communications technology. Furthermore, first SIM 18 may manage a first subscription (SUB) 19 and second SIM 8 may manage a second subscription 9. In another aspect, user equipment 10 may include one or more subscriber identity modules (SIMs), such as, as illustrated in FIG. 1, a first SIM 18 and a second SIM 8. However, the present disclosure is by no means limited to containing only two SIMs. For example, in some aspects, however, UE 10 may include more than two SIMs, such as a third, fourth, or any number of further SIMs (not shown). Additionally, each SIM of the one or more SIMS may have an associated subscription, each of which may support one or more technology type communication services, such as, but not limited to, one or more of 2G, 3G, and 4 G communication services.

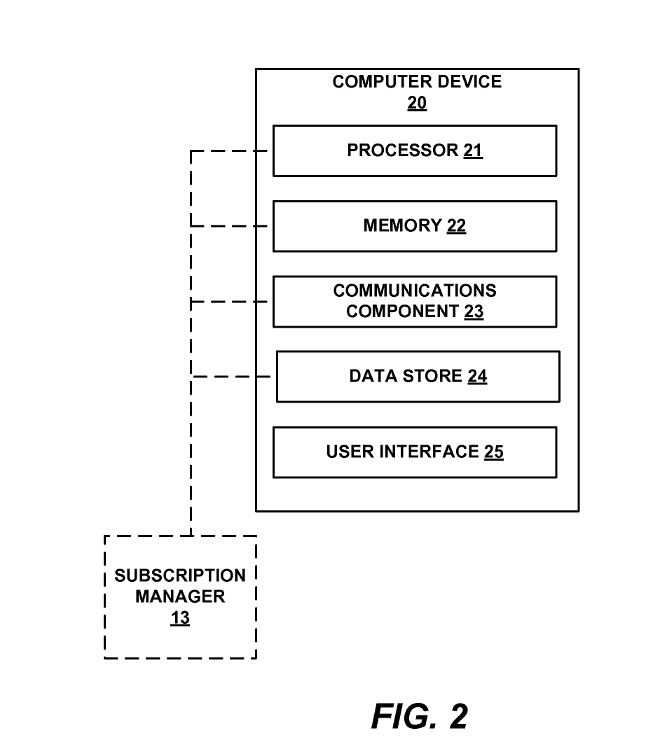

Referring to FIG. 2, in one aspect, any of UE 10, or the one or more network entities 11 (FIG. 1) may be represented by a specially programmed or configured computer device 20. Computer device 20 includes a processor 21 for carrying out processing functions associated with one or more of components and functions described herein. Processor 21 can include a single or multiple set of processors or multi-core processors. Moreover, processor 21 can be implemented as an integrated processing system and/or a distributed processing system.

Computer device 20 further includes a memory 22, such as for storing data used herein and/or local versions of applications being executed by processor 21. Memory 22 can include any type of memory usable by a computer, such as random access memory (RAM), read only memory (ROM), tapes, magnetic discs, optical discs, volatile memory, non-volatile memory, and any combination thereof.

Further, computer device 20 includes a communications component 23 that provides for establishing and maintaining communications with one or more parties utilizing hardware, software, and services as described herein. Communications component 23 may carry communications between components on computer device 20, as well as between computer device 20 and external devices, such as devices located across a communications network and/or devices serially or locally connected to computer device 20. For example, communications component 23 may include one or more buses, and may further include transmit chain components and receive chain components associated with a transmitter and receiver, respectively, or a transceiver, operable for interfacing with external devices. In an additional aspect, communications component 23 may be configured to receive one or more pages from one or more subscriber networks. In a further aspect, such a page may correspond to the second subscription and may be received via the first technology type communication services.

Additionally, computer device 20 may further include a data store 24, which can be any suitable combination of hardware and/or software, that provides for mass storage of information, databases, and programs employed in connection with aspects described herein. For example, data store 24 may be a data repository for applications not currently being executed by processor 21.

Computer device 20 may additionally include a user interface component 25 operable to receive inputs from a user of computer device 20, and further operable to generate outputs for presentation to the user. User interface component 25 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 25 may include one or more output devices, including but not limited to a display, a speaker, a haptic feedback mechanism, a printer, any other mechanism capable of presenting an output to a user, or any combination thereof. In an additional aspect, a user using the user interface 25 may set one of a first subscription or a second subscription as a dedicated data service (DDS) for the computer device 20.

In a mobile station implementation, such as for UE 10 of FIG. 1, computer device 20 may include subscription manager, such as in specially programmed computer readable instructions or code, firmware, hardware, or some combination thereof.

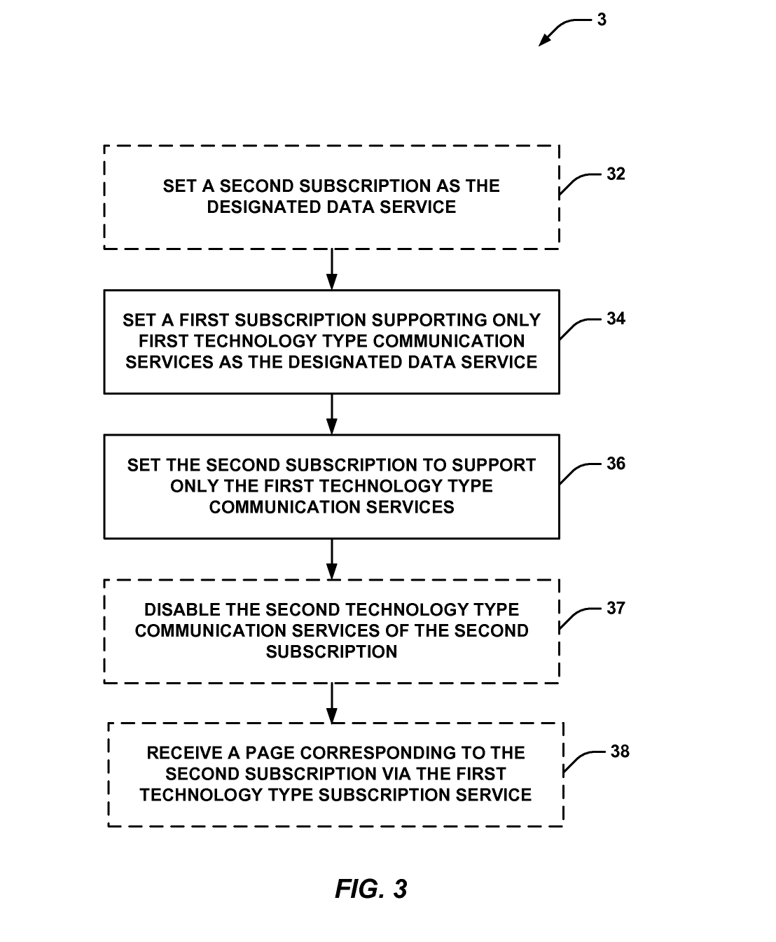

Referring to FIG. 3, an example methodology for improved tune-away in a UE is provided. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

In an aspect, at block 32, a subscription manager (or other component) of a UE (e.g. subscription manager 13 of UE 10, FIG. 1) may optionally set a second subscription as the dedicated data service (DDS) for the UE. In an example, the UE may perform this setting as a result of a UE user entering a command, such as selecting the second subscription as the DDS in a user interface. Furthermore, at block 34, the subscription manager (or other component) may set a first subscription, which may support only first technology type services, as the DDS. In an aspect, the first technology type communication services may be 2G services, such as, but not limited to, GSM, EDGE, and/or GPRS services. Furthermore, the first subscription may be managed by a first subscriber identity module.

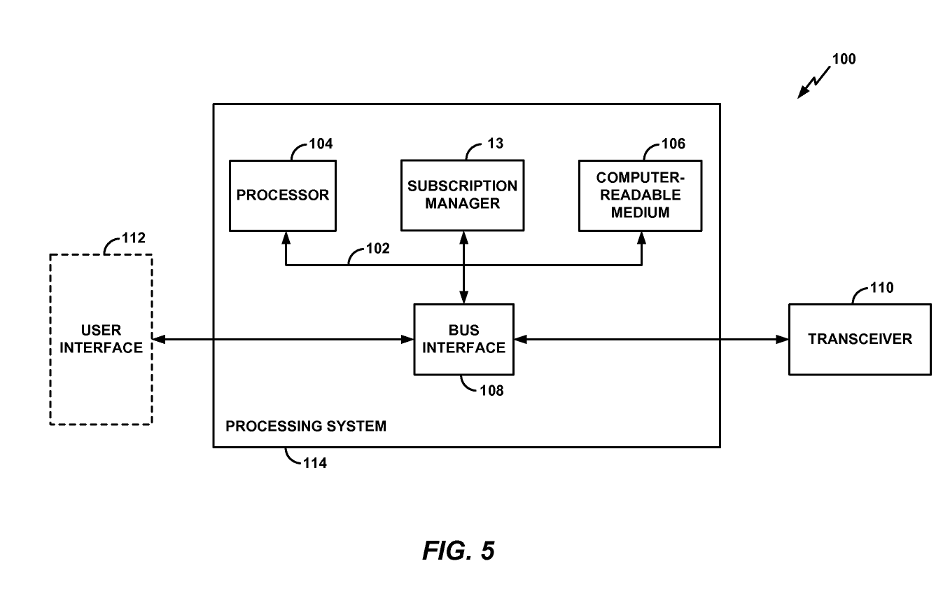

Furthermore, at block 36, the subscription manager (or other component) may set the second subscription to support only the first technology type communication services, where the second subscription may be able to support both the first technology type communication services and second technology type communication services. Moreover, setting the second subscription to support only the first technology type communication services may be a result of the subscription manager setting the first subscription to the DDS of the UE at block 34. In an aspect, second technology type communication services may be 3G services, such as, but not limited to WCDMA, DO, EV-DO, and/or TDS-CDMA services. In addition, the second subscription may be managed by a second subscriber identity module. Furthermore, second technology type communication services may be 4G services, such as, but not limited to, Long-Term Evolution (LTE), Time-Division Long-Term Evolution (TD-LTE), or any other fourth-generation mobile communications technology service. In a further optional aspect, the subscription manager may disable the second technology type communication services of the second subscription at block 37. As a result, the only technology type services available to the second subscription may be the first technology type communication services. Therefore, at block 38, the UE (e.g. via subscription manager 13 of FIGS. 1 and/or 5, communications component 23 of FIG. 2, and/or processor 104 of FIG. 5) may optionally receive a page corresponding to the second subscription via the first technology type subscription service, which may be the only enabled technology type communication service available on the second subscription. As such, UEs that are typically unable to tune away from a first subscription providing only a first technology type services to a second subscription providing a second technology type communication services may still receive a page, such as a voice page, via the second subscription.

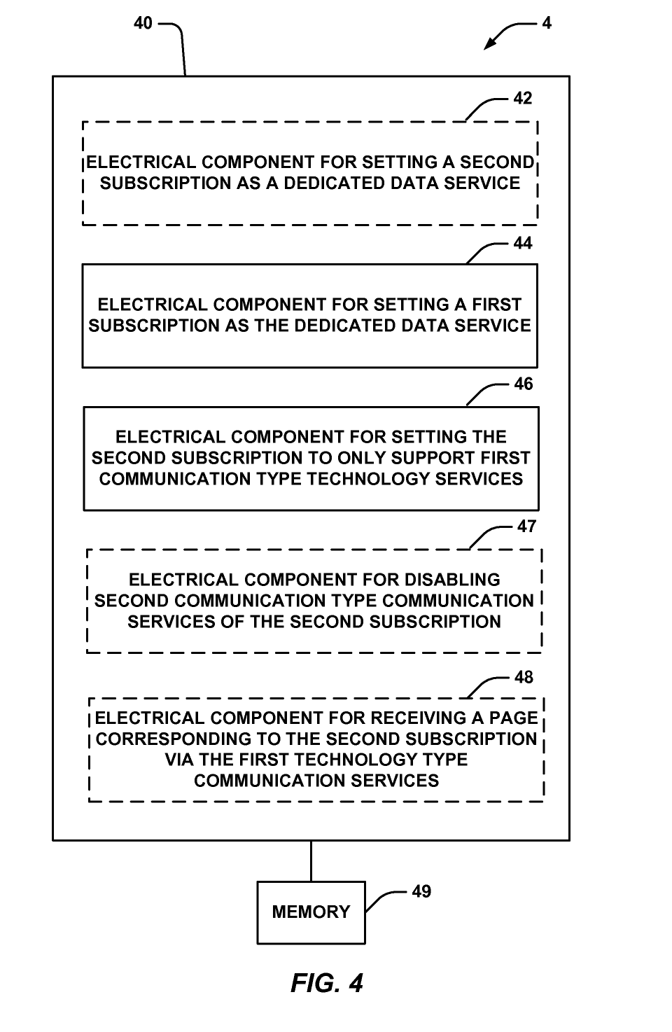

Referring to FIG. 4, an example system 4 is displayed for improved tune away in a UE. For example, system 4 can reside at least partially within one or more network entities. It is to be appreciated that system 4 is represented as including functional blocks, which can be functional blocks that represent functions implemented by a processor, software, or combination thereof (e.g., firmware). System 4 includes a logical grouping 40 of electrical components that can act in conjunction. For instance, logical grouping 40 can include an electrical component 42 for setting a second subscription as a dedicated data service. In an aspect, electrical component 42 may comprise second subscription technology setting component 16 (FIG. 1) and/or processor 21 (FIG. 2). In an additional aspect, logical grouping 40 can include an electrical component 44 for setting a first subscription as the dedicated data service. In an aspect, electrical component 44 may comprise first subscription technology setting component 14 (FIG. 1) and/or processor 21 (FIG. 2). In a further aspect, logical grouping 40 can include an electrical component 46 for setting the second subscription to only support first communication type technology services. In an aspect, electrical component 46 may comprise second subscription technology setting component 16 (FIG. 1). In a further aspect, logical grouping 40 can include an electrical component 47 for disabling second communication type communication services of the second subscription. In an aspect, electrical component 46 may comprise second subscription technology setting component 16 (FIG. 1).

Furthermore, in a further aspect, logical grouping 40 can include an electrical component 48 for receiving a page corresponding to the second subscription via the first technology type communication services. In an aspect, electrical component 46 may comprise communications component 23 (FIG. 2). Additionally, system 4 can include a memory 49 that retains instructions for executing functions associated with the electrical components 42, 44, 46, 47, and 48, stores data used or obtained by the electrical components 42, 44, 46, 47, and 48, etc. While shown as being external to memory 49, it is to be understood that one or more of the electrical components 42, 44, 46, 47, and 48 can exist within memory 49. In one example, electrical components 42, 44, 46, 47, and 48 can comprise at least one processor, or each electrical component 42, 44, 46, 47, and 48 can be a corresponding module of at least one processor. Moreover, in an additional or alternative example, electrical components 42, 44, 46, 47, and 48 can be a computer program product including a computer readable medium, where each electrical component 42, 44, 46, 47, and 48 can be corresponding code.

FIG. 5 is a block diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. Additionally, as indicated in FIG. 5, bus 102 may link subscription manager (e.g. subscription manager 13 of FIGS. 1 and 2) to bus interface 108 and/or other components in a UE implementation of processing system 114, such as, but not limited to, UE 10 of FIG. 1. For example, in some aspects, processing system 114 may comprise UE 10 of FIG. 1, wherein the processing system 114 may execute the functions of subscription manager 13 described above, such as, but not limited to, with processor 104 executing instructions stored on computer-readable medium 106 and defining the functions of subscription manager 13.

A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

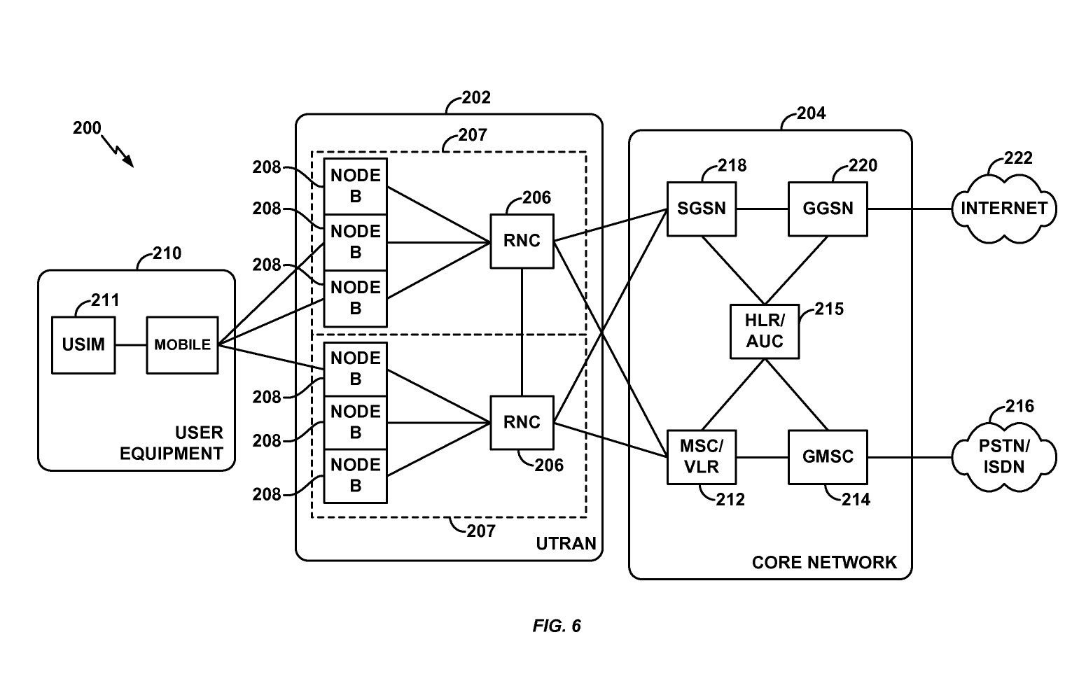

The various concepts presented throughout this disclosure may be implemented across a broad variety of telecommunication systems, network architectures, and communication standards. By way of example and without limitation, the aspects of the present disclosure illustrated in FIG. 6 are presented with reference to a UMTS system 200 employing a W-CDMA air interface. A UMTS network includes three interacting domains: a Core Network (CN) 204, a UMTS Terrestrial Radio Access Network (UTRAN) 202, and User Equipment (UE) 210. In an aspect, UE 210 may be UE 10 (FIG. 1), and UMTS 202 may comprise network entity 11 (FIG. 11). In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

Communication between a UE 210 and a Node B 208 may be considered as including a physical (PHY) layer and a medium access control (MAC) layer. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a CN 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The DL, also called the forward link, refers to the communication link from a Node B 208 to a UE 210, and the UL, also called the reverse link, refers to the communication link from a UE 210 to a Node B 208.

The CN 204 interfaces with one or more access networks, such as the UTRAN 202. As shown, the CN 204 is a GSM core network. However, as those skilled in the art will recognize, the various concepts presented throughout this disclosure may be implemented in a RAN, or other suitable access network, to provide UEs with access to types of CNs other than GSM networks.

The CN 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a VLR that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The CN 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 210 provides feedback to the node B 208 over the HS-DPCCH to indicate whether it correctly decoded a packet on the downlink.

HS-DPCCH further includes feedback signaling from the UE 210 to assist the node B 208 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the node B 208 and/or the UE 210 may have multiple antennas supporting MIMO technology. The use of MIMO technology enables the node B 208 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 210 to increase the data rate or to multiple UEs 210 to increase the overall system capacity. This is achieved by spatially precoding each data stream and then transmitting each spatially precoded stream through a different transmit antenna on the downlink. The spatially precoded data streams arrive at the UE(s) 210 with different spatial signatures, which enables each of the UE(s) 210 to recover the one or more the data streams destined for that UE 210. On the uplink, each UE 210 may transmit one or more spatially precoded data streams, which enables the node B 208 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

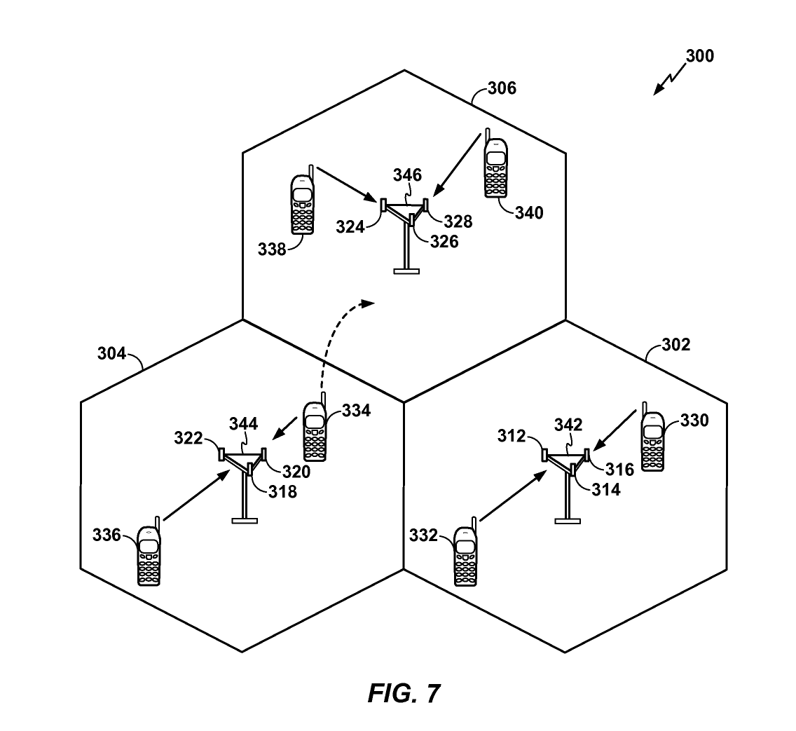

Referring to FIG. 7, an access network 300 in a UTRAN architecture is illustrated. The multiple access wireless communication system includes multiple cellular regions (cells), including cells 302, 304, and 306, each of which may include one or more sectors. The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a CN 204 (see FIG. 6) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 6), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

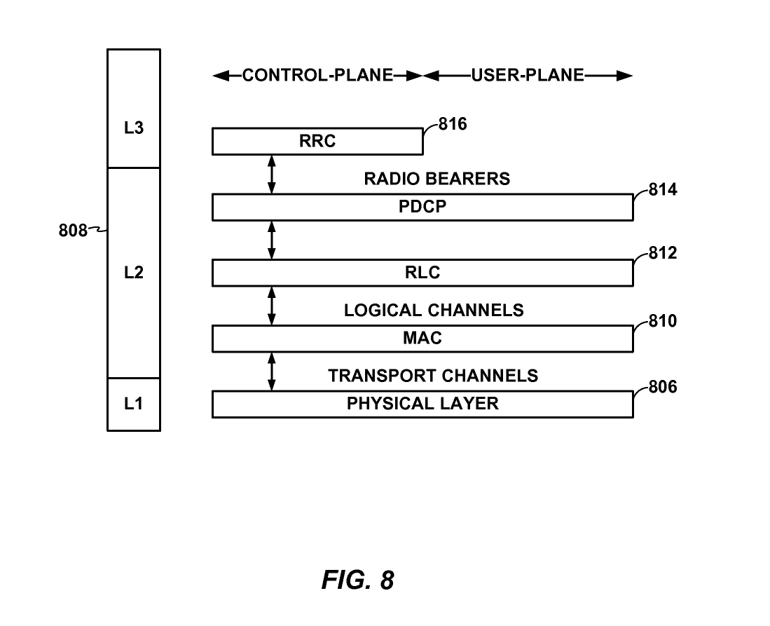

The radio protocol architecture may take on various forms depending on the particular application. An example for an HSPA system will now be presented with reference to FIG. 8. FIG. 8 is a conceptual diagram illustrating an example of the radio protocol architecture for the user and control planes.

Turning to FIG. 8, the radio protocol architecture for the UE and node B is shown with three layers: Layer 1, Layer 2, and Layer 3. Layer 1 is the lowest lower and implements various physical layer signal processing functions. Layer 1 will be referred to herein as the physical layer 806. Layer 2 (L2 layer) 808 is above the physical layer 806 and is responsible for the link between the UE and node B over the physical layer 806.

In the user plane, the L2 layer 808 includes a media access control (MAC) sublayer 810, a radio link control (RLC) sublayer 812, and a packet data convergence protocol (PDCP) 814 sublayer, which are terminated at the node B on the network side. Although not shown, the UE may have several upper layers above the L2 layer 808 including a network layer (e.g., IP layer) that is terminated at a PDN gateway on the network side, and an application layer that is terminated at the other end of the connection (e.g., far end UE, server, etc.).

The PDCP sublayer 814 provides multiplexing between different radio bearers and logical channels. The PDCP sublayer 814 also provides header compression for upper layer data packets to reduce radio transmission overhead, security by ciphering the data packets, and handover support for UEs between node Bs. The RLC sublayer 812 provides segmentation and reassembly of upper layer data packets, retransmission of lost data packets, and reordering of data packets to compensate for out-of-order reception due to hybrid automatic repeat request (HARQ). The MAC sublayer 810 provides multiplexing between logical and transport channels. The MAC sublayer 810 is also responsible for allocating the various radio resources (e.g., resource blocks) in one cell among the UEs. The MAC sublayer 810 is also responsible for HARQ operations.

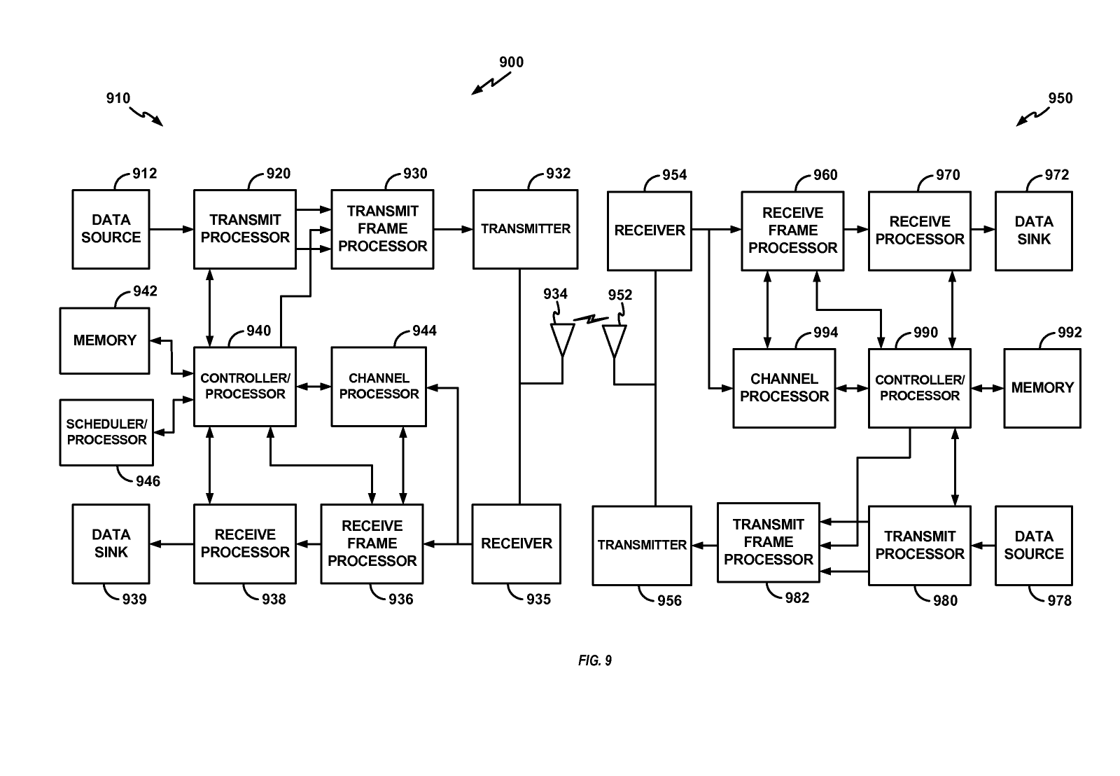

FIG. 9 is a block diagram of a Node B 910 in communication with a UE 950, where the Node B 910 may be the Node B 208 in FIG. 6, and the UE 950 may be the UE 210 in FIG. 6. In the downlink communication, a transmit processor 920 may receive data from a data source 912 and control signals from a controller/processor 940. The transmit processor 920 provides various signal processing functions for the data and control signals, as well as reference signals (e.g., pilot signals). For example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. These channel estimates may be derived from a reference signal transmitted by the UE 950 or from feedback from the UE 950. The symbols generated by the transmit processor 920 are provided to a transmit frame processor 930 to create a frame structure. The transmit frame processor 930 creates this frame structure by multiplexing the symbols with information from the controller/processor 940, resulting in a series of frames. The frames are then provided to a transmitter 932, which provides various signal conditioning functions including amplifying, filtering, and modulating the frames onto a carrier for downlink transmission over the wireless medium through antenna 934. The antenna 934 may include one or more antennas, for example, including beam steering bidirectional adaptive antenna arrays or other similar beam technologies.

At the UE 950, a receiver 954 receives the downlink transmission through an antenna 952 and processes the transmission to recover the information modulated onto the carrier. The information recovered by the receiver 954 is provided to a receive frame processor 960, which parses each frame, and provides information from the frames to a channel processor 994 and the data, control, and reference signals to a receive processor 970. The receive processor 970 then performs the inverse of the processing performed by the transmit processor 920 in the Node B 910. More specifically, the receive processor 970 descrambles and despreads the symbols, and then determines the most likely signal constellation points transmitted by the Node B 910 based on the modulation scheme. These soft decisions may be based on channel estimates computed by the channel processor 994. The soft decisions are then decoded and deinterleaved to recover the data, control, and reference signals. The CRC codes are then checked to determine whether the frames were successfully decoded. The data carried by the successfully decoded frames will then be provided to a data sink 972, which represents applications running in the UE 950 and/or various user interfaces (e.g., display). Control signals carried by successfully decoded frames will be provided to a controller/processor 990. When frames are unsuccessfully decoded by the receiver processor 970, the controller/processor 990 may also use an acknowledgement (ACK) and/or negative acknowledgement (NACK) protocol to support retransmission requests for those frames.

In the uplink, data from a data source 978 and control signals from the controller/processor 990 are provided to a transmit processor 980. The data source 978 may represent applications running in the UE 950 and various user interfaces (e.g., keyboard). Similar to the functionality described in connection with the downlink transmission by the Node B 910, the transmit processor 980 provides various signal processing functions including CRC codes, coding and interleaving to facilitate FEC, mapping to signal constellations, spreading with OVSFs, and scrambling to produce a series of symbols. Channel estimates, derived by the channel processor 994 from a reference signal transmitted by the Node B 910 or from feedback contained in the midamble transmitted by the Node B 910, may be used to select the appropriate coding, modulation, spreading, and/or scrambling schemes. The symbols produced by the transmit processor 980 will be provided to a transmit frame processor 982 to create a frame structure. The transmit frame processor 982 creates this frame structure by multiplexing the symbols with information from the controller/processor 990, resulting in a series of frames. The frames are then provided to a transmitter 956, which provides various signal conditioning functions including amplification, filtering, and modulating the frames onto a carrier for uplink transmission over the wireless medium through the antenna 952.

The uplink transmission is processed at the Node B 910 in a manner similar to that described in connection with the receiver function at the UE 950. A receiver 935 receives the uplink transmission through the antenna 934 and processes the transmission to recover the information modulated onto the carrier. The information recovered by the receiver 935 is provided to a receive frame processor 936, which parses each frame, and provides information from the frames to the channel processor 944 and the data, control, and reference signals to a receive processor 938. The receive processor 938 performs the inverse of the processing performed by the transmit processor 980 in the UE 950. The data and control signals carried by the successfully decoded frames may then be provided to a data sink 939 and the controller/processor, respectively. If some of the frames were unsuccessfully decoded by the receive processor, the controller/processor 940 may also use an acknowledgement (ACK) and/or negative acknowledgement (NACK) protocol to support retransmission requests for those frames.

The controller/processors 940 and 990 may be used to direct the operation at the Node B 910 and the UE 950, respectively. For example, the controller/processors 940 and 990 may provide various functions including timing, peripheral interfaces, voltage regulation, power management, and other control functions. The computer readable media of memories 942 and 992 may store data and software for the Node B 910 and the UE 950, respectively. A scheduler/processor 946 at the Node B 910 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of supporting tune-away in a wireless system, comprising:
setting a first subscription of a first subscriber identity module (SIM) of a user equipment (UE) as a designated data subscription (DDS), wherein the first subscription supports only first technology type communication services; and
setting a second subscription of a second SIM of the UE to support only the first technology type communication services in response to setting the first subscription as the DDS, wherein the second subscription is able to support both the first technology type communication services and second technology type communication services different than the first technology type communication services.

2. The method of claim 1, further comprising setting the second subscription as the DDS prior to setting the first subscription as the DDS.

3. The method of claim 1, further comprising receiving a page corresponding to the second subscription via the first technology type communication services.

4. The method of claim 1, further comprising disabling the second technology type communication services of the second subscription in response to setting the first subscription as the DDS.

5. The method of claim 1, wherein the first technology type communication services are 2G services and the second technology type communication services are at least one of 3G services and 4G services.

6. The method of claim 1, wherein the second technology type communication services are Time Division Synchronous Code Division Multiple Access services.

7. The method of claim 1, wherein the second technology type communication services are Data Optimized services.

8. The method of claim 1, wherein the first technology type communication services are Global System for Mobile Communications (GSM) services.

9. The method of claim 1, wherein the UE comprises two or more SIMs and each of the two or more SIMs has an associated subscription.

10. The method of claim 1, wherein each associated subscription supports one or more of 2G, 3G, and 4 G communication services.

11. A computer program product, comprising:
a computer-readable medium comprising executable code for:
setting a first subscription of a first subscriber identity module (SIM) of a user equipment (UE) as a designated data subscription (DDS), wherein the first subscription supports only first technology type communication services; and
setting a second subscription of a second SIM of the UE to support only the first technology type communication services in response to setting the first subscription as the DDS, wherein the second subscription is able to support both the first technology type communication services and second technology type communication services different than the first technology type communication services.

12. The computer program product of claim 11, wherein the computer-readable medium further comprises executable code for setting the second subscription as the DDS prior to setting the first subscription as the DDS.

13. The computer program product of claim 11, wherein the computer-readable medium further comprises executable code for receiving a page corresponding to the second subscription via the first technology type communication services.

14. The computer program product of claim 11, wherein the computer-readable medium further comprises executable code for disabling the second technology type communication services of the second subscription in response to setting the first subscription as the DDS.

15. The computer program product of claim 11, wherein the first technology type communication services are 2G services and the second technology type communication services are at least one of 3G services and 4G services.

16. The computer program product of claim 11, wherein the second technology type communication services are Time Division Synchronous Code Division Multiple Access services.

17. The computer program product of claim 11, wherein the second technology type communication services are Data Optimized services.

18. The computer program product of claim 11, wherein the first technology type communication services are Global System for Mobile Communications (GSM) services.

19. The computer program product of claim 11, wherein the UE comprises two or more SIMs and each of the two or more SIMs has an associated subscription.

20. The computer program product of claim 11, wherein each associated subscription supports one or more of 2G, 3G, and 4 G communication services.

21. An apparatus for supporting tune-away, comprising:
at least one processor; and
a memory coupled to the at least one processor, wherein the at least one processor is configured to:
set a first subscription of a first subscriber identity module (SIM) of a user equipment (UE) as a designated data subscription (DDS), wherein the first subscription supports only first technology type communication services; and
set a second subscription of a second SIM of the UE to support only the first technology type communication services in response to setting the first subscription as the DDS, wherein the second subscription is able to support both the first technology type communication services and second technology type communication services different than the first technology type communication services.

22. The apparatus of claim 21, wherein the at least one processor is further configured to set the second subscription as the DDS prior to setting the first subscription as the DDS.

23. The apparatus of claim 21, wherein the at least one processor is further configured to receive a page corresponding to the second subscription via the first technology type communication services.

24. The apparatus of claim 21, wherein the at least one processor is further configured to disable the second technology type communication services of the second subscription in response to setting the first subscription as the DDS.

25. The apparatus of claim 21, wherein the first technology type communication services are 2G services and the second technology type communication services are at least one of 3G services and 4G services.

26. The apparatus of claim 21, wherein the second technology type communication services are Time Division Synchronous Code Division Multiple Access services.

27. The apparatus of claim 21, wherein the second technology type communication services are Data Optimized services.

28. The apparatus of claim 21, wherein the first technology type communication services are Global System for Mobile Communications (GSM) services.

29. The apparatus of claim 21, wherein the UE comprises two or more SIMs and each of the two or more SIMs has an associated subscription.

30. The apparatus of claim 21, wherein each associated subscription supports one or more of 2G, 3G, and 4 G communication services.

31. An apparatus for supporting tune-away in a wireless system, comprising:
means for setting a first subscription of a first subscriber identity module (SIM) of a user equipment (UE) as a designated data subscription (DDS), wherein the first subscription supports only first technology type communication services; and
means for setting a second subscription of a second SIM of the UE to support only the first technology type communication services in response to setting the first subscription as the DDS, wherein the second subscription is able to support both the first technology type communication services and second technology type communication services different than the first technology type communication services.

32. The apparatus of claim 31, further comprising means for setting the second subscription as the DDS prior to setting the first subscription as the DDS.

33. The apparatus of claim 31, further comprising means for receiving a page corresponding to the second subscription via the first technology type communication services.

34. The apparatus of claim 31, further comprising disabling the second technology type communication services of the second subscription in response to setting the first subscription as the DDS.

35. The apparatus of claim 31, wherein the first technology type communication services are 2G services and the second technology type communication services are at least one of 3G services and 4G services.

36. The apparatus of claim 31, wherein the second technology type communication services are Time Division Synchronous Code Division Multiple Access services.

37. The apparatus of claim 31, wherein the second technology type communication services are Data Optimized services.

38. The apparatus of claim 31, wherein the first technology type communication services are Global System for Mobile Communications (GSM) services.

39. The apparatus of claim 31, wherein the UE comprises two or more SIMs and each of the two or more SIMs has an associated subscription.

40. The apparatus of claim 31, wherein each associated subscription supports one or more of 2G, 3G, and 4 G communication services.
